(19) United States
(12) Patent Application Publication
(10) Pub. No.: US 2003/0109762 A1
(43) Pub. Date: Jun. 12, 2003

(54) Method and apparatus for pyrolysis

(76) Inventor: Shibata Akira, Suita-shi Osaka (JP)

Correspondence Address: DARBY & DARBY P.C., P. O. BOX 5257, NEW YORK, NY, 10150-5257, US

(21) Appl. No.: 10/333,637

(22) PCT Filed: Mar. 29, 2001
(86) PCT No.: PCT/JP01/02654

(30) Foreign Application Priority Data
Jul. 25, 2000 (JP) 2000-223813

(51) Int. Cl. C10G 1/10; B09B 3/00

(52) U.S. Cl. 585/241; 48/197 R; 48/210; 48/76; 48/61; 201/25

(57) ABSTRACT

A method for pyrolysis, characterized in that a material to be treated is heated to a temperature lower than the decomposition temperature of dioxins and the resulting gaseous components are cooled and liquefied; and an apparatus for practicing the method comprising a heating means (1) and a cooling and liquefying means (2) for the gaseous components formed by the above heating. The method can be employed for pyrolyzing a material to be treated with safety and at a lower cost as compared to a conventional method for pyrolysis.

### FIELD OF THE INVENTION

The present invention relates to a method for pyrolysis including a method for burning and others more safely and at a lower cost as compared to a conventional method for pyrolysis, and to an apparatus therefor.

1. Description of the Related Art

Conventionally when plastics including chloride are burned up in an incinerator, if they are burned imperfectly, extremely poisonous dioxins could be generated.

Dioxins which have been exhausted into the air pollute the environment so much that, in a burning process, a burning temperature should be heated up to above 800° C., at which dioxins are supposed to be decomposed and destroyed.

However, a problem is that an incinerator resistible against such a high temperature requires very expensive materials.

Therefore, it is an object of the present invention to provide a method for pyrolysis that can be employed more safely and at a lower cost as compared to a conventional method for pyrolysis, and an apparatus therefor.

2. Summary of the Invention

In order to resolve the abovementioned problem, a method for pyrolysis according to the present invention includes heating materials to be treated to a temperature lower than the decomposition temperature of dioxins, and cooling and liquefying the resultant gaseous components.

According to this method for pyrolysis, it is liable to generate dioxins, since materials to be treated are heated up to a temperature lower than the decomposition temperature of dioxins. However, resultant dioxins do not exhaust into the air because gaseous components including dioxins are cooled and liquefied. That is to say even the burning process at a lower temperature as compared to a conventional method will not exhaust dioxins into the air.

In addition to the above stated, there are some other methods for pyrolysis such as a method for burning materials to be treated with oxygen, and a method for steaming and burning under controlling a supply of oxygen.

Components that are not liquefied under the cooling and liquefying process can be reheated with another batch of materials to be treated that are being heated.

According to these processes, it is possible to obtain a reliable method as a whole by continuation of re-treatment in which unliquefied components are reheated to be liquefied.

The apparatus for pyrolysis according to the present invention includes a heating means and a cooling and liquefying means. The heating means heats up materials to be treated to a temperature lower than the decomposition temperature of dioxins, and the cooling and liquefying means liquefies the resultant gaseous components. This apparatus provides the same function as stated above as to the method for pyrolysis.

### BRIEF DESCRIPTION OF DRAWINGS

FIG. 1 is a system flowchart to show an embodiment of the method and apparatus for pyrolysis according to the present invention.

### DESCRIPTION OF PREFERRED EMBODIMENTS

An apparatus for pyrolysis of an embodiment is made for a burning apparatus to burn materials to be treated.

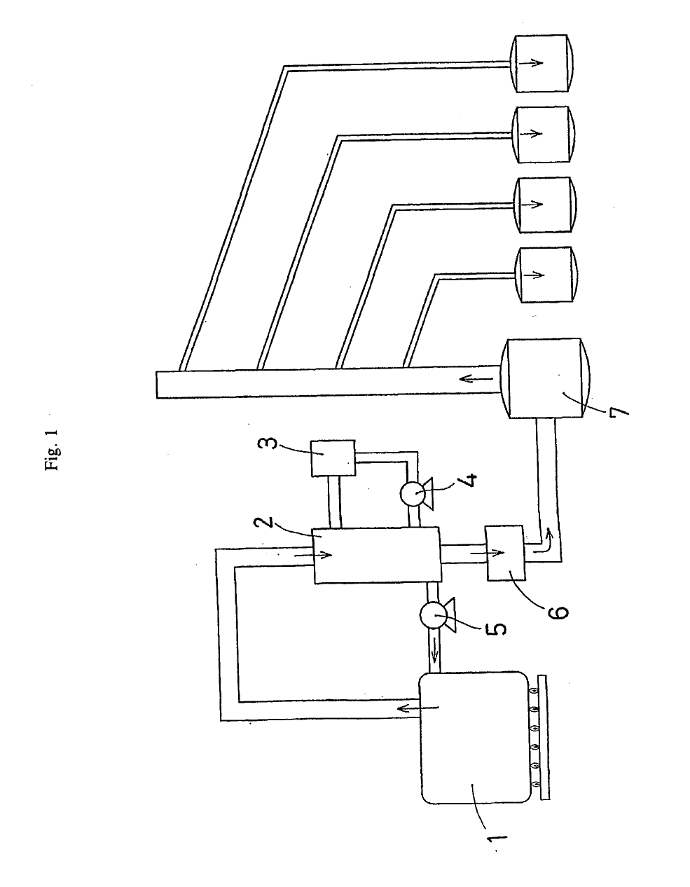

The burning apparatus (an apparatus for pyrolysis), as shown in FIG. 1, includes a heating means 1 (e.g. an incinerator) and a cooling and liquefying means 2 (e.g. a condenser). A method for pyrolysis includes heating up materials to be treated (or burned) to a temperature below the decomposition temperature of dioxins by the heating means (the incinerator) below the decomposition temperature of dioxins (approx. 400° C.), and liquefying resultant gaseous components from the above heating by the cooling and liquefying means 2 (the condenser). The condenser is linked with a cooling fan 3 and a cooling water fan 4.

Gaseous components that are not liquefied under the cooling and liquefying process are taken back to the heating means 1 (the incinerator) by a drawing means 5 (e.g. a drawing fan) and are reheated with another batch of materials to be treated that are being heated therein. Cooled and liquefied components, meanwhile, are withdrawn into a tank 6 and are led into a fractionating column 7 to be fractionated. Each of the fractionated components that is usable is reused.

In the apparatus and the method, it is liable to generate dioxins because materials to be treated (to be burned) are heated up to a temperature (approx. 400° C.) lower than the decomposition temperature of dioxins. However, generated gaseous components such as dioxins are liquefied in the cooling and liquefying means 2 (the condenser), and they do not exhaust into the air.

That is to say, even if the burning process is practised at a lower temperature as compared to a conventional method (approx. 40° C.), dioxins do not exhaust into the air. Therefore, the apparatus and the method are inexpensive because an expensive, high-temperature-resistant burning apparatus is not necessary, and safe as dioxins do not exhaust into the air.

Furthermore, it is not necessary to heat materials to be burned up to above 800° C., at which dioxins are supposed to be decomposed and destroyed, or to use special materials for the apparatus that are resistible to such a high temperature. This advantageously results in a longer life of the apparatus.

Unliquefied components under the cooling and liquefying are taken back to the heating means 1 (the incinerator) and reheated together with another batch of materials to be treated (to be burned) that are being heated therein. Therefore, the present invention advantageously provides a reliable process as a whole with continuous and repetitious re-treatment.

Possibility for Industrial Applicability

Constituted as stated above, the present invention provides inexpensive and reliable method and apparatus for pyrolysis with no exhaustion of dioxins in the air even with heating process at a lower temperature as compared to a conventional method. Therefore, for example, the present invention is applicable to an inexpensive and safe pyrolysis method when materials to be treated including plastics containing chloride are burned, and also applicable to a burning and incinerating apparatus for materials to be treated.

1. A method for pyrolysis comprising: heating up materials to be treated to a temperature lower than a decomposition temperature of dioxins; cooling and liquefying resultant gaseous components; and fractionating the cooled and liquefied components to make respective fractionated components reusable.

2. A method for pyrolysis according to claim 1 further comprising reheating unliquefied components after the cooling and liquefying process together with another batch of materials that are being heated.

3. An apparatus for pyrolysis comprising: a heating means and a cooling and liquefying means; said heating means heating up materials to be treated up to a temperature below a decomposition temperature of dioxins, and said cooling and liquefying means liquefying generated gaseous components by heating; and wherein cooled and liquefied components are fractionated and made to be reused.
